(19) United States
(12) Patent Application Publication
(10) Pub. No.: US 2022/0253781 A1
(43) Pub. Date: Aug. 11, 2022

(54) METHOD, DEVICE AND COMPUTER READABLE STORAGE MEDIUM FOR DATA PROCESSING

(71) Applicant: NEC Corporation, Tokyo (JP)

(72) Inventors: Zheng Pan, Beijing (CN); Lu Feng, Beijing (CN)

(73) Assignee: NEC Corporation, Tokyo (JP)

(21) Appl. No.: 17/667,270

(22) Filed: Feb. 8, 2022

(30) Foreign Application Priority Data
Feb. 9, 2021 (CN) 2021101822588

(51) Int. Cl. G06Q 10/06; G06Q 30/02; G06Q 30/00

(52) U.S. Cl. CPC G06Q 10/06375; G06Q 30/016; G06Q 30/0282

(57) ABSTRACT

Embodiments of the present disclosure relate to a method, apparatus and computer readable storage medium for data processing. The method may include obtaining a causal result determined based on reference data of a plurality of reference factors. The plurality of reference factors may include a reference satisfaction degree and other reference factors, and the causal result may include a causal relationship between the reference satisfaction degree and the other reference factors and a causal relationship between the other reference factors. The method may further include obtaining sample data of a plurality of user factors associated with a user, the plurality of user factors at least partially overlapping the other reference factors. The method may further include determining a first satisfaction degree of the user based on the sampled data and the causal result. The technical solution of the present disclosure can predict the user's satisfaction degree timely and accurately and automatically make an optimization policy and improve the user's experience.

### FIELD

Embodiments of the present disclosure mainly relate to the field of computers, and more specifically to a method, device, electronic device and computer storage medium for data processing.

### BACKGROUND

In order to understand the user's evaluation of related products as timely as possible, the user's satisfaction degree for the related products is usually surveyed on a regular basis. For example, a manufacturer or service provider usually initiates a questionnaire to obtain information on user's satisfaction degree, thereby providing guidance information for improving the user experience. With the rapid development of information technology, the user's data scale grows rapidly, and the original manual questionnaire survey operations and data analysis operations are increasingly unable to provide satisfaction degree information thoroughly and timely. Against such a background and trend, machine learning has drawn more and more attention.

### SUMMARY

According to example embodiments of the present disclosure, a data processing solution is provided.

In a first aspect of the present disclosure, there is provided a data processing method. The method may include obtaining a causal result determined based on reference data of a plurality of reference factors. The plurality of reference factors may include a reference satisfaction degree and other reference factors, and the causal result may include a causal relationship between the reference satisfaction degree and the other reference factors and a causal relationship between the other reference factors. The method may further include obtaining sample data of a plurality of user factors associated with a user, the plurality of user factors at least partially overlapping the other reference factors. The method may further include determining a first satisfaction degree of the user based on the sampled data and the causal result.

In a second aspect of the present disclosure, there is provided an apparatus for data processing, comprising: at least one processing unit; and at least one memory coupled to the at least one processing unit and storing instructions for execution by the at least one processing unit, the instructions, when executed by the at least one processing unit, causing the apparatus to perform actions comprising: obtaining a causal result determined based on reference data of a plurality of reference factors, the plurality of reference factors comprising a reference satisfaction degree and other reference factors, and the causal result comprising a causal relationship between the reference satisfaction degree and other reference factors and a causal relationship between other reference factors; obtaining sample data of a plurality of user factors associated with a user, the plurality of user factors at least partially overlapping the other reference factors; and determining a first satisfaction degree of the user based on the sampled data and the causal result.

In a third aspect of the present disclosure, there is provided a data processing method. The method may include obtaining model data associated with a trained causal model and a satisfaction prediction degree model. The method may further include determining a causal result based on the causal model and reference data of a plurality of reference factors, the plurality of reference factors comprising a reference satisfaction degree and other reference factors, the causal result comprising a causal relationship between reference satisfaction degree and other reference factors and a causal relationship between other reference factors. The method may further include obtaining sample data of a plurality of user factors associated with a user. Additionally, the method may include determining a first satisfaction degree of the user based on the satisfaction degree prediction model, the sample data, and the causal result.

In a fourth aspect of the present disclosure, there is provided a computer-readable storage medium having stored thereon machine-executable instructions that, when executed by a device, cause the device to perform the method according to the first aspect.

This Summary is provided to introduce a selection of concepts that are further described below in the Detailed Description in a simplified form. This Summary is not intended to identify key features or essential features of the present disclosure, nor is it intended to be used to limit the scope of the claimed subject matter. Other features of the present disclosure will be made more apparent by the following depictions.

### BRIEF DESCRIPTION OF THE DRAWINGS

In conjunction with the accompanying drawings and with reference to the following detailed description, the above and other features, advantages, and aspects of embodiments of the subject matter described herein will become more apparent. In the figures, identical or like reference numbers denote identical or like elements, wherein:

FIG. 1 illustrates a block diagram of an example system for data processing according to an embodiment of the present disclosure;

FIG. 2 illustrates a schematic diagram for determining a causal relationship between multiple factors according to an embodiment of the present disclosure;

FIG. 3 illustrates a flowchart of an exemplary data processing process according to an embodiment of the present disclosure;

FIG. 4 illustrates a flowchart of a process of determining a policy according to an embodiment of the present disclosure;

FIG. 5 illustrates a flowchart of a process for obtaining expert knowledge to update a causal result according to an embodiment of the present disclosure;

FIG. 6 illustrates a block diagram of another example system for data processing according to an embodiment of the present disclosure; and

FIG. 7 illustrates a schematic block diagram of an example device that may be used to implement an embodiment of the present disclosure.

### DETAILED DESCRIPTION OF EMBODIMENTS

Hereinafter, embodiments of the subject matter described herein will be described in more detail with reference to the accompanying drawings. Although some embodiments of the subject matter described herein are illustrated in the drawings, it is to be understood that the subject matter described herein may be implemented through various forms, but may not be interpreted as being limited to the embodiments illustrated herein. On the contrary, these embodiments are only intended to understand the subject matter described herein more thoroughly and completely. It is to be understood that the accompanying drawings and embodiments of the subject matter described herein are only for the purpose of illustration, without suggesting any limitation of the protection scope of the subject matter described herein.

As used herein, the terms “comprises”, “comprises” or like terms should be appreciated as open-ended terms that mean “comprises, but is not limited to.” The term “based on” is to be read as “based at least in part on.” The term “one example embodiment” and “an example embodiment” are to be read as “at least one example embodiment.” The terms “first,” “second,” and the like may refer to different or same objects. Other definitions, explicit and implicit, may be comprised below.

In the embodiments of the present disclosure, the term “causal result” generally refers to a causal diagram that describes a causal relationship among factors in a system, and may also be referred to herein as a “causal relationship sequence”. The term “factor” is also referred to as a “variable”. The terms “reference data” and “sample data” refer to a set of data about a number of factors that can be viewed directly.

The survey of the user's satisfaction degree is generally conducted through a professionally designed questionnaire. Such a survey generally needs to be carried out periodically. The cycle for acquiring survey is long, the cost is high, and the information is lagging behind. It is impossible to find service problems in time and to obtain all users' perception experience of the service, which does not help the service provider to adjust the service policy thoroughly.

In order to determine which factors will affect the user's satisfaction with the service or product provider, it is possible to collect one or more types of data among the user's usage behavior data and consumption behavior data for the service or product, survey data on satisfaction, and the service or product provider's policy data for the service or product. Each type of data collected is also referred to as data of a factor (or variable).

One or more factors that affect the satisfaction degree can be determined by discovering the causal relationships that exist between these factors. Furthermore, the user's current satisfaction degree information may be predicted based on the user data collected in real time, and a corresponding policy may be worked out based on the satisfaction degree information and the user data collected in real time to improve the user's satisfaction with the service or product provider. For example, for the satisfaction degree for a telecommunication operator, it is possible to collect historical consumption behavior data (such as user attributes, monthly consumption of Internet traffic, ratio of free traffic, total fee of monthly consumed Internet traffic, etc.), survey data on the satisfaction degree, and features data of factors such as evaluation and complaint information of a large number of users. The user's satisfaction degree for the telecommunication service being used may be predicted based on a corresponding causal relationship between each user data and the satisfaction degree data obtained from the survey and the user data (excluding satisfaction degree information) collected in time. Furthermore, a corresponding policy may be made to improve the user's satisfaction degree for the telecommunication operator. For another example, for the satisfaction degree for a software product (such as a travel service providing website), user behavior data, satisfaction degree data acquired from the survey, etc. may be collected. The user's satisfaction degree for the software product may be predicted based on the corresponding causal relationship between the usage behavior data and the satisfaction degree data acquired from the survey and the usage behavior data collected in real time. It is to be understood that the above examples are only exemplary, and the present disclosure is also applicable to fields of other products or services for which the satisfaction degree information needs to be acquired from surveys.

However, the above data processing manner only considers the causal relationship between other factors and the user satisfaction degree and does not consider the causal relationship between other factors when determining the user satisfaction degree. Taking the telecommunication service as an example, it should be appreciated that network quality exerts a direct influence on the user satisfaction degree, and meanwhile the network quality also indirectly affects the user satisfaction degree through factors such as voice call duration and expenses beyond the service package (because if the network quality is not good, the would have to use voice call more other than WeChat call). If the causal relationship between the factors is not considered, there will be at least two problems: 1. If only the direct influence of network quality on satisfaction is considered, without considering the indirect influence between the factors, the weight estimation performed by a prediction model will be made inaccurate; 2. Since the voice call duration has no direct influence on the satisfaction degree, this factor will not be included in the prediction model, which will lead to inaccurate selection of the factor. Based on at least these two problems, the prediction results for the user satisfaction degree are still not accurate enough.

According to an embodiment of the present disclosure, a solution for data processing is proposed. This solution can comprehensively implement the prediction of the user satisfaction degree and policy making based on the causal result, thereby solving the above problems and/or other potential problems. Embodiments of the present disclosure will be described in detail below in conjunction with the above-mentioned example scenarios. It should be appreciated that this is for illustrative purposes only and is not intended to limit the scope of the invention in any way.

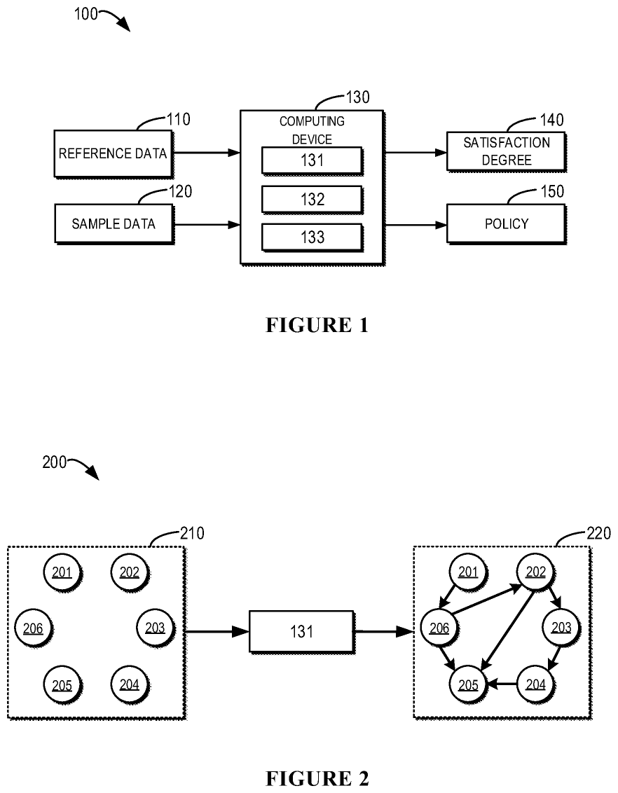

FIG. 1 illustrates an example block diagram of a system 100 for data processing according to an embodiment of the present disclosure. It should be appreciated that the system 100 shown in FIG. 1 is merely one example in which embodiments of the present disclosure may be implemented, and is not intended to limit the scope of the present disclosure. Embodiments of the present disclosure are also applicable to other systems or architectures.

As shown in FIG. 1, the system 100 may include a computing device 130. The computing device 130 may be configured to receive reference data 110 of a plurality of reference factors and sample data 120 for a plurality of user factors. As an example, the reference factors and the user factors substantially overlap, and may respectively be multiple items associated with user behavior, attributes, etc. The difference lies in that the reference factors include a reference satisfaction degree item, whereas the user factors do not include the reference satisfaction degree item. Therefore, the reference data 110 may be full user data associated with user behaviors, attributes, etc., and includes surveyed user satisfaction degree data, and the sample data 120 may be user data associated with the user behaviors, attributes, etc. other than the user satisfaction degree items.

As shown in FIG. 1, the computing device 130 receives reference data 110 of a plurality of reference factors and uses a causal model 131 arranged therein to determine a causal result of these reference factors. The causal result may include a causal relationship between the reference satisfaction degree and other reference factors, as well as a causal relationship between other reference factors. After the sample data 120 is input into the computing device 130, a satisfaction degree prediction model 132 arranged in the computing device 130 may determine the user's satisfaction degree 140 based on the sample data 120 and the predetermined causal relationship described above. Furthermore, when the satisfaction degree 140 meets a predetermined condition, a policy optimization model 133 arranged in the computing device 130 may determine a policy 150 to be provide to the user, based on an adjustment of the sample data 120 and the predetermined causal relationship described above. Although not shown, computing device 130 may usually further have a function of performing conventional preprocessing on reference data 110 and sample data 120. The preprocessing for example may include abnormal data detection, data cleaning, missing value filling, sample filtering, factor selection, etc., to improve data quality.

It should be appreciated that the causal model 131, the satisfaction degree prediction model 132, and the policy optimization model 133 may be respectively implemented as a causal relationship analysis module, a satisfaction degree prediction module and a policy optimization module that are implemented based on software, and they may use extracted existing data to learn specific knowledge to process new data. Examples of the causal model 131, the satisfaction degree prediction model 132 and the policy optimization model 133 include, but are not limited to, various types of Deep Neural Networks (DNN), Convolutional Neural Networks (CNN), Support Vector Machines (SVM), decision trees, and random forest models etc.

Taking the above-mentioned scenario about the user satisfaction degree for the telecommunication operator as an example, the reference factors may include one or more types of factors related to user attributes (for example, user level, user gender, user age, etc.), factors related to the service provided by the operator to the user (for example, package name, monthly package value, monthly consumption value, etc.), factors related to the user behavior (for example, monthly calling/called communication duration, monthly consumption of Internet traffic, ratio of free traffic, the total value of monthly consumed Internet traffic, the number of logins onto related websites/APPs, webpage-browsing historical information of related websites/APPs, etc.), and factors related to user feedback (for example, the number of complaints, the content of complaints, and user satisfaction degree). The causal model 131 may for example determine the causal relationship between the user attributes, monthly consumption of Internet traffic, the ratio of free traffic, the total value of monthly consumed Internet traffic, etc. and the causal relationship between these factors and the user satisfaction degree. After receiving the sample data 120, the computing device 130 may determine the causal relationship between the user factors of the sample data 120 and the causal relationship between the user factors and the satisfaction degree 140 to be determined based on the causal relationship determined above. Thus, the satisfaction degree prediction model 132 may predict the user's satisfaction degree 140, and the policy optimization model 133 may determine a more appropriate optimized policy 150.

It should be appreciated that the devices and/or units in the devices included in the system 100 are exemplary only, and are not intended to limit the scope of the present disclosure. It should be appreciated that the system 100 may further include additional devices and/or units not shown. For example, in some embodiments, the computing device 120 of the system 100 may further include a causal relationship presenting device (not shown) for presenting the causal relationship sequence of the above-mentioned multiple factors in the form of a causal diagram.

In some embodiments, the causal relationship presenting device may further present corresponding importance degrees of a plurality of factors, for example, present corresponding importance degrees of the plurality of factors by means of numerical values (such as influence coefficients) representing different importance degrees. Embodiments of the present disclosure are not limited in this regard.

It should be appreciated that the reference data 110 and the causal model 131 are used to predetermine causal relationships between a plurality of reference factor items comprising satisfaction degree items. FIG. 2 illustrates a schematic diagram for determining a causal relationship between a plurality of reference factors according to an embodiment of the present disclosure. For the purpose of simplicity and ease of illustration, it is assumed in FIG. 2 that the reference data 210 involves six reference factors 201, 202, 203, 204, 205 and 206. It should be appreciated that the number of factors involved may be any number, e.g., may be much greater than six.

As shown in FIG. 2, the reference data 210 includes a plurality of data about the reference factors 201, 202, 203, 204, 205 and 206. In an initial case, as shown by reference data 210 in FIG. 2, there may be a causal relationship between any two factors.

In some embodiments, the feature data 210 may be input to the causal model 131 in the computing device 130 to determine the causal relationships that may exist among multiple reference factors 201, 202, 203, 204, 205 and 206. It should be appreciated that the computing device 130 may use any known or future-developed causal analysis processing manners to determine the causal relationship that might exist among the plurality of reference factors 201, 202, 203, 204, 205 and 206. As an example, the causal model 131 may be a machine learning model such as a causal relationship determining device, the machine learning model being trained to determine the causal relationship among factors in a training data set based on training data sets of the plurality of users, thereby determining the causal relationship among these reference factors. Alternatively or additionally, the machine learning model may be a Convolutional Neural Network (CNN).

As shown in FIG. 2, assuming that the reference factor 205 is the reference satisfaction degree, the causal result 220 output by the causal model 131 for example indicates that the reference factor 201 is the cause of the reference factor 206, the reference factor 206 is the cause of the reference factor 202 and the reference factor 205, the reference factor 202 is the cause of reference factor 203 and reference factor 205, the reference factor 203 is the cause of reference factor 204, and the reference factor 204 is the cause of reference factor 205.

Taking the above-mentioned scenario of user satisfaction degree for the telecommunication operator as an example, the reference factor 205 is the user's “tariff satisfaction degree”, the reference factor 206 is a factor related to voice consumption, and the reference factor 202 is a factor related to traffic consumption. As shown in FIG. 2, the reference factor 206 related to voice consumption may be the direct cause of the reference factor 205 regarding tariff satisfaction, or may indirectly act on the tariff satisfaction degree 205 through a conditional factor of the reference factor 202 regarding the traffic consumption. That is, a value corresponding to the reference factor 206 related to voice consumption affects the user's tariff satisfaction degree corresponding to the reference factor 205. The present disclosure not only considers the causal relationship between the reference factors 201, 202, 203, 204, 206 and the reference factor 205, but also considers the causal relationship between the reference factors 201, 202, 203, 204 and 206 upon predicting the user satisfaction degree data and determining the optimization policy, thereby implementing the satisfaction degree prediction and policy optimization more accurately.

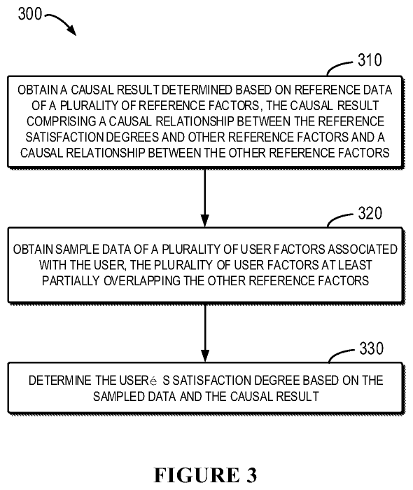

FIG. 3 illustrates a flowchart of an exemplary data processing process 300 according to an embodiment of the present disclosure. For example, the process 300 may be performed by the computing device 130 as shown in FIG. 1. It should be appreciated that the process 300 may also include additional actions not shown and/or certain actions shown may be omitted. The scope of the present disclosure is not limited in this regard.

At 310, the computing device 130 may obtain a causal result determined based on the reference data 110 of a plurality of reference factors. As an example, these reference factors may include a reference satisfaction degree, and may further include other reference factors. For example, factors related to user attributes (such as user level, user gender, user age, etc.), factors related to the services provided by operators to users (such as package name, monthly package value, monthly consumption value, etc.), factors related to user behavior (for example, monthly calling/calling communication duration, monthly consumption of Internet traffic, the ratio of free traffic, the total value of monthly consumed Internet traffic, the number of logins onto related websites/APPs, webpage-browsing historical information of related websites/APPs etc.) and so on. In some embodiments, the causal model 131 disposed in computing device 130 may determine a causal result based on the reference data 110. The causal result may include the causal relationship between the reference satisfaction degree and other reference factors and the causal relationship between other reference factors. It should be appreciated that the reference data 110 may be historical data related to a large number of users, and used to predetermine the causal relationship between the factors of the sample data 120. Alternatively or additionally, the reference data 110 may also be real-time data related to batches of users, but it is necessary to ensure that the data contains the user satisfaction degree information obtained from the survey.

In some embodiments, a preprocessing process such as feature engineering may be performed for the input reference data 110. For example, a proportion of voice consumption of a user may be obtained by dividing a value corresponding to a factor related to voice consumption by a total consumption value, a proportion of the number of actively initiated services of a certain user may be obtained by dividing the number of actively initiated services by the total number of services, a voice margin ratio of a certain user is obtained by dividing a calling duration by the voice service charge, and so on, and these processed data are vectorized.

At 320, the computing device 130 may further obtain the sample data 120 of a plurality of user factors associated with the user. These user factors overlap at least in part with the aforementioned reference factors. As an example, the difference between the user factors and the above reference factors lies in that the user factors do not include the user's satisfaction degree, that is, the user's satisfaction degree information is to be determined. The computing device may also perform the above-described preprocessing process on the input sample data 120. It should be appreciated that, in order to operate on the user at various granularities, the user may be a single user, or may be a set of users belonging to a specific group.

At 330, the computing device 130 may predict the user's satisfaction degree 140 based on the sample data 120 and the causal result determined based on the reference data 110 of the plurality of reference factors. In some embodiments, the satisfaction degree prediction model 132 disposed in the computing device 130 may predict the satisfaction degree 140 based on the predetermined causal result of the plurality of reference factors and the sample data 120 input in real time.

As an example, the computing device 130 may apply the sample data 120 and the causal results determined based on the reference data 110 of the plurality of reference factors to the satisfaction degree prediction model 132 to determine the satisfaction degree 140. In some embodiments, the satisfaction degree prediction model 132 is obtained by training by considering reference sample data and a reference causal result as input, and by considering a corresponding annotated reference satisfaction degree as output.

It should be appreciated that the satisfaction degree prediction model 132 may also be updated based on a difference between a predicted satisfaction degree and an actual satisfaction degree. As an example, the computing device 130 may update satisfaction degree prediction model 132 based on determined satisfaction degree 140 and the actual satisfaction received from the user.

Through the above embodiments, the present disclosure may achieve automated user satisfaction degree prediction, thereby achieving dynamic monitoring of the user satisfaction degree. Specifically, the present disclosure may predict the satisfaction degrees of a large number of users (e.g., millions of or tens of millions of users or more) by surveying a limited number of users (e.g., hundreds or thousands of users or less) at a regular or irregular interval and building a causal model with the data of these users. In addition, since the present disclosure not only considers the causal relationship between the factors and the satisfaction degree, but also considers the causal relationship between the factors when predicting the satisfaction degrees and making the optimization policy, so that both the prediction of the satisfaction degree and the making of the optimization policy will be more accurate.

In some embodiments, after determining the predicted satisfaction degree 140, the computing device 130 may the predicted satisfaction degree 140 with a predetermined threshold. As an example, if the predicted satisfaction degree 140 is determined to be below a first threshold satisfaction degree, an alarm signal is generated. In this way, the staff may be notified to timely pay attention to users whose satisfaction degrees do not meet expectations, and regard these users as object to whom the optimization policy or soothing policy is applied.

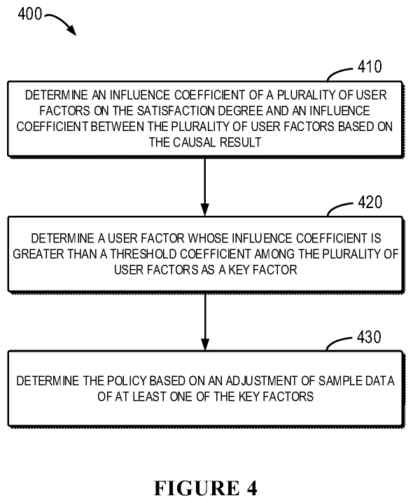

In addition, if it is determined that the predicted satisfaction degree 140 is lower than a first threshold satisfaction degree, the computing device may also determine a policy 150 for changing the satisfaction degree 140 based on the sample data 120, and provide the policy 150 to the user in time, thereby improving the user experience timely and effectively. For convenience of presentation, the process of determining the optimization policy will be described in detail below with reference to FIG. 4.

FIG. 4 illustrates a flowchart of a process 400 of determining a policy according to an embodiment of the present disclosure. For example, the process 400 may be performed by the computing device 130 as shown in FIG. 1. It should be appreciated that the process 400 may also include additional actions not shown and/or certain actions shown may be omitted. The scope of the present disclosure is not limited in this regard.

At 410, the computing device 130 may determine influence coefficients of the plurality of user factors on the satisfaction degree and influence coefficients between the plurality of user factors based on the above-mentioned causal results. As an example, the computing device 130 may determine, based on the reference data, influence factors of the factors other than the satisfaction degree among these factors on the satisfaction degree and influence factors among the other factors. As an example, in the telecommunications operator scenario described above, the computing device 130 may determine the influence factors of other factors on the satisfaction degree and influence factors among the other factors by using any known or future-developed processing manner. For example, the influencing factors of factors as target actors on the satisfaction degree are: a, b, c, d . . . , and the influencing factors between the factors are w, x, y, z . . . , respectively.

At 420, the computing device 130 may determine a user factor whose influence coefficient is greater than a threshold coefficient among the plurality of user factors as a key factor. Furthermore, at 430, the computing device 130 may determine the policy based on the adjustment of the sample data for at least one of the key factors. As an example, all adjustment modes may be combined traversally. It should also be understood that, in order to ensure that policy optimization may be achieved at each granularity, the recognition of key factors here may include recognition of group key factors and recognition of individual key factors. In this way, individuals or groups for who a corresponding policy is provided may be determined based on the predicted satisfaction degree.

In some embodiments, alternative policies may be determined based on the adjustment of the sample data of at least one of the factors described above. As an example, the policy optimization model arranged in the computing device 130 may determine an alternative policy based on a plurality of alternative adjustment manners of the abovementioned at least one factor. The computing device 130 may then determine an adjusted satisfaction degree based on the adjusted sample data and the causal result. If the adjusted satisfaction degree is higher than an expected second threshold satisfaction degree, or higher than the satisfaction degree 140, then the alternative policy may be determined as the policy 150. It will be appreciated that the user may be allowed to set a desired target for the optimization policy. As an example, the policy target may be a single target, for example, the satisfaction degree is greater than a threshold; the policy target may also be a plurality of targets, for example, the satisfaction degree is greater than a threshold, and the input cost does not exceed a threshold. Further, the computing device 130 may receive an input operation for one or more expected targets, and perform the step of determining the policy.

In some embodiments, the computing device 130 may determine one or more alternative policies based on the influence coefficients among the reference factors. It should be appreciated that computing device 130 may be manufactured to include a machine learning models with a simulation capability. The machine learning model is trained to determine the influence factors of other reference factors in the reference factors on the reference satisfaction degree and the influence factors between other reference factors based on the reference data, and then determine the policy 150 for a part of user factors with higher influence factors among the user factors 150. Preferably, since the corresponding cost of each factor is different, a factor with a high influence factor might have a higher cost, the policy 150 may be determined by selecting the user factor with a higher influence factor while controlling the cost.

As an example, in the above-mentioned telecommunication operator scenario, the machine learning model may determine, according to the reference data, that the influence factors of factors as target factors on the satisfaction degree are a, b, c, d . . . , respectively, and the influence factors among the factors are w, x, y, z . . . , respectively. Furthermore, the machine learning model may determine reference factors with high influence factors and make a policy for a corresponding user factor. These policies are determined as alternative policies. Furthermore, the satisfaction degree of each alternative policy is predicted by the satisfaction degree prediction model 132. When the satisfaction degree is higher than a threshold, the alternative policy may be determined as the policy 150. Preferably, an alternative policy with the highest predicted satisfaction degree may be determined as the policy 150.

In addition, it is possible to further receive or monitor the real satisfaction degree data fed back by the users after the policy is applied. The predicted satisfaction degree for the policy 150 may be compared with an actual satisfaction degree fed back by the user. If the increase of the satisfaction degree after policy optimization does not meet expectations, it means that the policy optimization model 133 needs to be updated. Therefore, the policy optimization model 133 may be further trained based on information such as the updated reference data.

It should be appreciated that, in addition to updating the satisfaction degree prediction model 132 and the policy optimization model 133, the causal model 131 may also be updated in order to more accurately predict the satisfaction degree and make optimization policy.

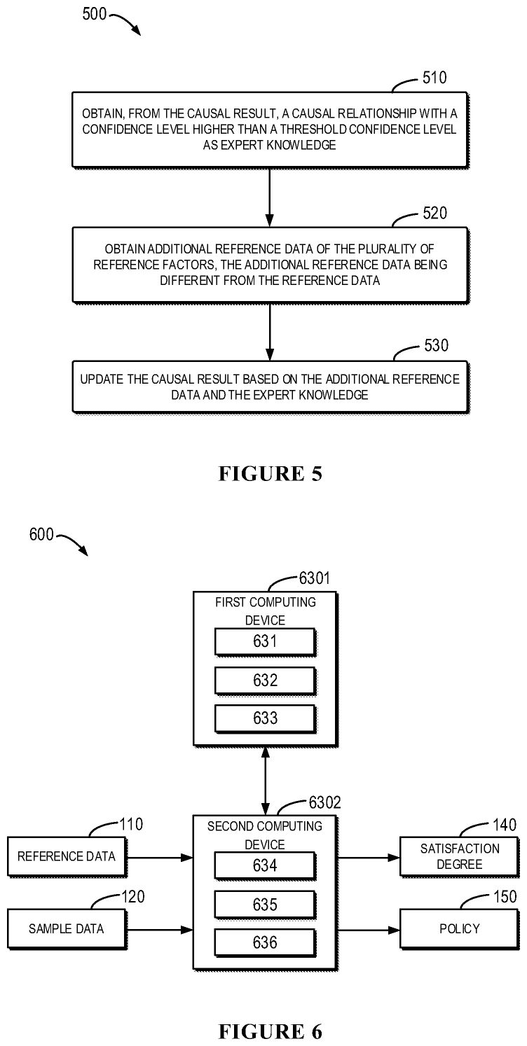

FIG. 5 illustrates a flowchart of a process of obtaining expert knowledge to update the causal result according to an embodiment of the present disclosure. For example, the process 500 may be performed by computing device 130 as shown in FIG. 1. It should be appreciated that the process 500 may also include additional actions not shown and/or certain actions shown may be omitted. The scope of the present disclosure is not limited in this regard.

At 510, the computing device 130 may obtain, from the causal result, a causal relationship with a confidence level above a threshold confidence level, as expert knowledge. As an example, the computing device 130 may determine the confidence level of each causal relationship while determining the causal result, and select a causal relationship with a higher confidence level as the expert knowledge. Alternatively or additionally, since survey data is typically updated periodically, the causal results may be re-determined each time new survey data is obtained. A causal relationship that exists stably among causal results determined many times may be determined as the expert knowledge. In addition, after the formulated policy 150 is implemented, the computing device 130 may use the satisfaction degree prediction model 132 to evaluate the satisfaction degree and improve the effect, thereby discovering which measures in the policy are more effective. These measures may be determined as key influencing factors as the expert knowledge.

At 520, the computing device 130 may obtain updated reference data of the plurality of reference factors. The updated reference data of the plurality of reference factors may be survey data updated regularly or irregularly. Then, at 530, the computing device 130 may update the causal model 131 based on the updated reference data and expert knowledge, thereby updating the causal result. In this way, the causal model 131 may be enabled to accurately and quickly determine the causal result by determining the expert knowledge.

FIG. 6 illustrates a block diagram of another example system 600 for data processing according to an embodiment of the present disclosure. It should be appreciated that another example system 600 shown in FIG. 6 is merely one example in which embodiments of the present disclosure may be implemented, and is not intended to limit the scope of the present disclosure. Embodiments of the present disclosure are also applicable to other systems or architectures.

As shown in FIG. 6, different from the system 100 in FIG. 1, the system 600 includes a first computing device 6301 and a second computing device 6302. The second computing device 6302 is similar to the computing device 130 in FIG. 1, and therefore is not repeated here. The first computing device 6301 is added to the system 600.

In some embodiments, the causal model 631 in the first computing device 6301 corresponds to the causal model 634 in the second computing device 6302, that is, the second computing device 6302 obtains, from the first computing device 6301, model data associated with trained causal model 631 and satisfaction degree prediction model 632. The second computing device 6302 may then determine a causal result based on the causal model 634 and the reference data 110 for the plurality of reference factors. These reference factors include a reference satisfaction degree and other reference factors, and the causal result includes causal relationships between the reference satisfaction degree and other reference factors and causal relationships between other reference factors. The second computing device 6302 may obtain sample data for a plurality of user factors associated with the user and determine the user's satisfaction degree 140 based on the satisfaction degree prediction model 635, the sample data 120, and the causal result. In addition, the second computing device 6302 may also determine the policy 150 based on the policy optimization model 636, the sample data 120, and the causal result.

It should be appreciated that for a service provider or a product provider, the first computing device 6301 and the second computing device 6302 may be arranged at different locations, and the second computing device 6302 may be a plurality of computing devices which are computing entities independent from the first computing device 6301. The first computing device 6301 is used to train the causal model 631, the satisfaction degree prediction model 632 and the policy optimization model 633 based on a certain amount of user data, and deliver the trained models to the second computing device 6302 to form the causal model 634, the satisfaction degree prediction model 635 and policy optimization model 636. Since the second computing device 6302 may be arranged closer to the users under its jurisdiction, the user data may be processed in time. It should be appreciated that both the first computing device 6301 and the second computing device 6302 may implement training and updating of the models arranged therein.

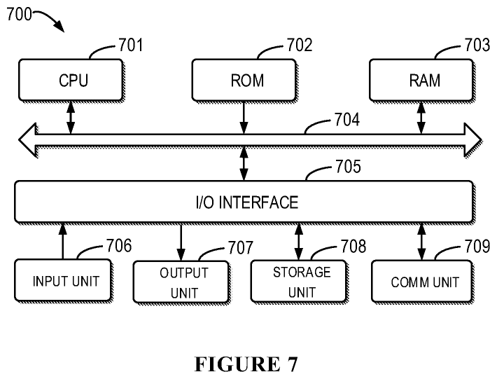

FIG. 7 illustrates a block diagram of an example device 700 that can be used to implement embodiments of the present disclosure. For example, the computing device 130 shown in FIG. 1 may be implemented by the device 700. As shown in the figure, the device 700 comprises a central processing unit (CPU) 701 that may perform various appropriate actions and processing based on computer program instructions stored in a read-only memory (ROM) 702 or computer program instructions loaded from a storage unit 708 to a random access memory (RAM) 703. In the RAM 703, there further store various programs and data needed for operations of the device 700. The CPU 701, ROM 702 and RAM 703 are connected to each other via a bus 704. An input/output (I/O) interface 705 is also connected to the bus 704.

Various components in the device 700 are connected to the I/O interface 705, comprising: an input unit 706 such as a keyboard, a mouse and the like; an output unit 707 comprising various kinds of displays and a loudspeaker, etc.; a storage unit 708 comprising a magnetic disk, an optical disk, and etc.; a communication unit 709 comprising a network card, a modem, and a wireless communication transceiver, etc. The communication unit 709 allows the device 700 to exchange information/data with other devices through a computer network such as the Internet and/or various kinds of telecommunications networks. It should be understood that in the present disclosure the output unit 707 may be used to display real-time dynamic change information of the user satisfaction degree, key factor recognition information of group users or individual users with the satisfaction degree, optimization policy information, and policy implementation effect evaluation information.

The processing unit 701 may be implemented through one or more processing circuits. The processing unit 701 may be configured to perform various processes and processing described above, for example, processes 300, 400 and/or 500. For example, in some embodiments, the processes 300, 400 and/or 500 may be implemented as a computer software program that is tangibly included in a machine readable medium, e.g., the storage unit 708. In some embodiments, part or all of the computer program may be loaded and/or mounted onto the device 700 via ROM 702 and/or communication unit 709. When the computer program is loaded to the RAM 703 and executed by the CPU 701, one or more steps of the methods 300, 400 and/or 500 as described above may be executed.

The present disclosure may be a system, a method and/or computer program product. The computer program product may include a computer readable storage medium on which computer readable program instructions for executing various aspects of the present disclosure are embodied.

The computer readable storage medium may be a tangible device that may retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, comprising an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, comprising a local area network (LAN) or a wide area network (WAN), or the connection may be made to an external computer (for example, through the Internet using an Internet Service Provider). In some embodiments, electronic circuitry comprising, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processing unit of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein comprises an article of manufacture comprising instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A data processing method, comprising:
obtaining a causal result determined based on reference data of a plurality of reference factors, the plurality of reference factors comprising a reference satisfaction degree and other reference factors, and the causal result comprising a causal relationship between the reference satisfaction degree and the other reference factors and a causal relationship between the other reference factors;
obtaining sample data of a plurality of user factors associated with a user, the plurality of user factors at least partially overlapping the other reference factors; and
determining a first satisfaction degree of the user based on the sampled data and the causal result.

2. The method according to claim 1, further comprising:
generating an alarm signal if determining that the first satisfaction degree is lower than a first threshold satisfaction degree.

3. The method according to claim 1, further comprising:
determining a policy for changing the first satisfaction degree based on the sample data; and
providing the user with the policy.

4. The method according to claim 3, wherein determining the policy based on the sample data comprises:
determining an influence coefficient of the plurality of user factors on the first satisfaction degree and an influence coefficient between the plurality of user factors based on the causal result;
determining a user factor whose influence coefficient is greater than a threshold coefficient among the plurality of user factors as a key factor; and
determining the policy based on an adjustment of sample data of at least one of the key factors.

5. The method according to claim 4, wherein determining the policy comprises:
determining an alternative policy based on the adjustment of the sample data for the at least one factor;
determining a second satisfaction degree based on the adjusted sample data and the causal result; and
determining the alternative policy as the policy if determining that the second satisfaction degree is higher than a second threshold satisfaction degree.

6. The method according to claim 1, further comprising:
obtaining, from the causal result, a causal relationship with a confidence level higher than a threshold confidence level as expert knowledge;
obtaining updated reference data of the plurality of reference factors; and
updating the causal results based on the updated reference data and the expert knowledge.

7. The method according to claim 1, wherein determining the first satisfaction degree comprises:
applying the sample data and the causal result to a satisfaction degree prediction model to determine the first satisfaction degree, the satisfaction degree prediction model being obtained by training by considering reference sample data and a reference causal result as input, and by considering a corresponding annotated reference satisfaction degree as output.

8. The method according to claim 7, further comprising:
updating the satisfaction degree prediction model based on the determined first satisfaction degree and the satisfaction degree received from the user.

9. The method according to claim 1, wherein the user belongs to a set of users in a specific group.

10. A data processing method, comprising:
obtaining model data associated with a trained causal model and a satisfaction prediction degree model;
determining a causal result based on the causal model and reference data of a plurality of reference factors, the plurality of reference factors comprising a reference satisfaction degree and other reference factors, the causal result comprising a causal relationship between the reference satisfaction degree and other reference factors and a causal relationship between the other reference factors;
obtaining sample data of a plurality of user factors associated with a user;
determining a first satisfaction degree of the user based on the satisfaction degree prediction model, the sample data, and the causal result.

11. The method according to claim 10, further comprising:
obtaining additional model data associated with a trained policy optimization model;
upon determined that the first satisfaction degree is lower than a first threshold satisfaction level, using the policy optimization model to determine a policy for changing the first satisfaction degree based on the sample data; and
providing the policy to the user

12. An electronic device, comprising:
at least one processing unit; and
at least one memory coupled to the at least one processing unit and storing instructions for execution by the at least one processing unit, the instructions, when executed by the at least one processing unit, causing the device to perform actions comprising:
obtaining a causal result determined based on reference data of a plurality of reference factors, the plurality of reference factors comprising a reference satisfaction degree and other reference factors, and the causal result comprising a causal relationship between the reference satisfaction degree and other reference factors and a causal relationship between the other reference factors;
obtaining sample data of a plurality of user factors associated with a user, the plurality of user factors at least partially overlapping the other reference factors; and
determining a first satisfaction degree of the user based on the sampled data and the causal result.

13. The device according to claim 12, wherein the actions further comprise:
generating an alarm signal if determining that the first satisfaction degree is lower than a first threshold satisfaction degree.

14. The device according to claim 12, wherein the actions further comprise:
determining a policy for changing the first satisfaction degree based on the sample data; and
providing the user with the policy.

15. The device according to claim 14, wherein determining the policy based on the sample data comprises:
determining an influence coefficient of the plurality of user factors on the first satisfaction degree and an influence coefficient between the plurality of user factors based on the causal result;
determining a user factor whose influence coefficient is greater than a threshold coefficient among the plurality of user factors as a key factor; and
determining the policy based on an adjustment of sample data of at least one of the key factors.

16. The device according to claim 15, wherein determining the policy comprises:
determining an alternative policy based on the adjustment of the sample data for the at least one factor;
determining a second satisfaction degree based on the adjusted sample data and the causal result; and
determining the alternative policy as the policy if determining that the second satisfaction degree is higher than a second threshold satisfaction degree.

17. The device according to claim 12, wherein the actions further comprise:
obtaining, from the causal result, a causal relationship with a confidence level higher than a threshold confidence level as expert knowledge;
obtaining updated reference data of the plurality of reference factors; and
updating the causal results based on the updated reference data and the expert knowledge.

18. The device according to claim 12, wherein determining the first satisfaction degree comprises:
applying the sample data and the causal result to a satisfaction degree prediction model to determine the first satisfaction degree, the satisfaction degree prediction model being obtained by training by considering reference sample data and a reference causal result as input, and by considering a corresponding annotated reference satisfaction degree as output.

19. The device according to claim 18, wherein the actions further comprise:
updating the satisfaction degree prediction model based on the determined first satisfaction degree and the satisfaction degree received from the user.

20. The device according to claim 12, wherein the user belongs to a set of users in a specific group.

21. (canceled)
